(19) United States
(12) Patent Application Publication
(10) Pub. No.: US 2007/0108654 A1
(43) Pub. Date: May 17, 2007

(54) Method and device for producing a double-walled plastics material moulded part with at least one inserted component

(76) Inventor: Manfred Geiss, Sesslach (DE)

Correspondence Address: JENKINS, WILSON, TAYLOR & HUNT, P. A., 3100 TOWER BLVD, SUITE 1200, DURHAM, NC, 27707, US

(21) Appl. No.: 11/598,364

(22) Filed: Nov. 13, 2006

(30) Foreign Application Priority Data
Nov. 11, 2005 (DE) 102005053917.3

(51) Int. Cl. B28B 23/02

(52) U.S. Cl. 264/252; 264/253

(57) ABSTRACT

In a method for producing a double-walled plastics material moulded part from portions of lengths of plastics material including at least one inserted component utilizing a closable housing of a thermoforming or vacuum moulding machine, upper and lower portions of a length of material are inserted into the opened housing between an upper and a lower housing portion by means of upper and lower conveying devices. The upper and lower portions are held apart via a twin-sheet frame. To seal the portions of length of material and the twin-sheet frame and simultaneously to hold the portions of the length of material with a slight excess pressure during heating prior to producing deformed upper and lower portions of the length of material, the upper portion of the length of material is pressed onto the twin-sheet frame in a region above it by a movable clamping frame and simultaneously the lower portion of the length of material is pressed against the lower housing portion to create a closed chamber. The deformed upper and lower portions are produced by moulding the portions of the length of material by upper and lower dies spaced apart without bonding contact. The clamping frame, the upper die, the upper conveying device, and the deformed upper portion are moved away with the upper housing portion from the lower housing portion at a distance for inserting the at least one component. The at least one component is placed on the deformed lower portion and the clamping frame, the upper die, the upper conveying device, and the deformed upper portion are moved away from the lower housing portion to close and bond the moulded part to the at least one inserted component.

### BACKGROUND OF THE INVENTION

The invention relates to a method and a device for producing a double-walled plastics material moulded part from portions of lengths of plastics material with at least one inserted component in a closable housing of a thermoforming or vacuum-moulding machine.

Vacuum moulding machines or thermoforming machines are already known in the prior art, which produce double-walled moulded parts according to a so-called “twin-sheet method”. Here so-called “closed chamber” machines are used, in which two sheets of plastics material stretched over one another rest tightly against the machine housing. This means it is possible to compensate correspondingly for any sagging of the material which occurs on heating by excess pressure and thermoformed parts or twin-sheet moulded parts of any size can be produced.

From German patent No. 42 23 785 C1 it is furthermore known, after the two blanks of material have been bonded also to remove them from the twin-sheet frame, closed in airtight manner, in an automatic process. This is done in that the four side walls of the twin-sheet frame move outwards in each case and form a larger opening for the bonded moulded part to drop down. According to this known method, however, only blanks of plastics material, but not continuous lengths of plastics material can be processed.

To process continuous lengths of material, published German application for patent No. 10 2004 002 431 A1 discloses configuring a frame part situated at the front in the conveying direction of the length of material as able to be pushed out laterally to release the moulded part bonded in the length of material.

The two aforementioned inventions in a favourable manner allow automatic production of twin-sheet parts and, owing to the provision of a closed machine housing and an airtight twin-sheet frame, advantageously enable the two material blanks or the solid portions of the continuous length of material to be constantly supported by excess pressure. However, with neither of the two aforementioned devices is it possible to introduce at least one additional component during production of the double-walled plastics material moulded part.

### BRIEF DESCRIPTION OF INVENTION

Accordingly the object of the invention is to make available a method and a device of the kind initially mentioned, according to which or with which plastics material moulded parts of this kind can be produced quickly and reliably and without problems with at least one inserted component.

The object is achieved in accordance with the invention by means of a method for producing a double-walled plastics material moulded part from portions of lengths of plastics material with at least one inserted component in a closable housing of a thermoforming or vacuum moulding machine, comprising the steps of:

(a) an upper and a lower portion of a length of material are inserted into the open housing between an upper and a lower housing portion by means of respective conveying devices and held apart via a twin-sheet frame;

(b) to seal this arrangement of portions of material and twin-sheet frame and at the same time to hold the two portions of the length of material with a slight excess pressure during heating prior to the deformation, the upper portion of the length of material is pressed onto the twin-sheet frame in the region above it by a movable clamping frame and therefore simultaneously the lower portion of the length of material is pressed against the lower housing portion of the vacuum moulding machine to create a closed chamber;

(c) the two portions of the length of material are moulded by respective dies spaced apart without bonding contact;

(d) the clamping frame, the upper die, the upper conveying device and the deformed upper portion of the length of material are moved with the upper housing portion from the lower housing portion at a distance for inserting the at least one component, the deformed portions of the length of material being held in each case under vacuum in the allocated housing portions;

(e) the at least one component is placed on the deformed lower portion of the length of material and

(f) the clamping frame, the upper die, the upper conveying device and the deformed upper portion of the length of material are moved back to the lower housing portion to close and bond the moulded part to the at least one inserted component.

The object is also achieved in accordance with the invention by means of a device for producing a double-walled plastics material moulded part from portions of lengths of plastics material with at least one inserted component in a closable housing of a thermoforming or vacuum moulding machine, wherein the housing has a lower housing portion and an upper housing portion, between which an upper and a lower portion of a length of material are movable by means of allocated conveying devices when the housing is not closed, in that when the housing is closed, arranged between the portions of the length of material is an airtight twin-sheet frame, the upper portion of the length of material being pressed by means of a clamping frame onto the twin-sheet frame the twin-sheet frame being pressed onto the lower portion of the material and the lower portion of the length of material being pressed onto a window plate of the lower housing portion for sealing and in that the upper housing portion can be moved away from the lower housing portion, after the individual portions of the length of material have been moulded and before the moulded part has been closed and bonded, at a distance which is sufficient for inserting the at least one component.

On the basis of the inventive method and the inventive device, the production of a double-walled plastics material moulded part from portions of lengths of plastics material with at least one inserted component is configured extraordinarily quickly and reliably and therefore without rejects. By means of the provided handling of the length of plastics material and its allocation to the respective halves of the housing for holding and sealing, not only is high-quality thermoforming or vacuum moulding possible, but it is also possible to operate with a high number of cycles, in order to achieve high production piece numbers.

Owing to the clamping measures provided for the upper portion of the length of material and the lower portion of the length of material to the airtight twin-sheet frame, the movable clamping frame and the window plate on the lower housing portion, an airtight arrangement is created, whereby advantageously both portions of the length of material are carried by slight excess pressure during heating before subsequent shaping. To shape the portions of the length of material the dies provided in each housing portion are brought together, though no bonding contact is provided. The clamping frame, the upper die, the upper conveying device, in particular in the form of a pin chain bar, and the upper moulded part or the deformed upper portion of the length of material then move upwards with the upper housing portion to move them away from the lower housing portion. A lifting device is provided for this, which, together with the upper deformed portion of the length of material and the clamping frame, also lifts the so-called conveying device, especially in the form of the upper pin chain bars, to such a distance from the lower housing portion that at least one component can be arranged on a suitable portion of the lower deformed portion of the length of material without problems. Moving back of the upper housing portion then takes place for complete closing and bonding of the at least one inserted component.

### BRIEF DESCRIPTION OF THE DRAWINGS

The invention is explained in greater detail below with reference to the attached drawings, in which:

FIG. 1 is a schematic partial illustration of a region inside a vacuum moulding machine, in which in each case an edge of a portion of a length of material to be heated is held at a distance;

FIG. 2 is an illustration similar to FIG. 1, wherein the heated portions of the length of material have now been deformed by respective dies, not illustrated, by the vacuum-moulding method without bonding;

FIG. 3 is an illustration similar to FIG. 1, wherein, however, the upper housing portion is lifted upwards from the lower housing portion in order to insert a component; and

FIG. 4 is an illustration similar to FIG. 1, wherein, however, the upper housing portion and the lower housing portion are closed and the double-walled plastics material moulded part is with an inserted component produced by bonding the two deformed portions of the length of material.

### DETAILED DESCRIPTION OF THE INVENTION

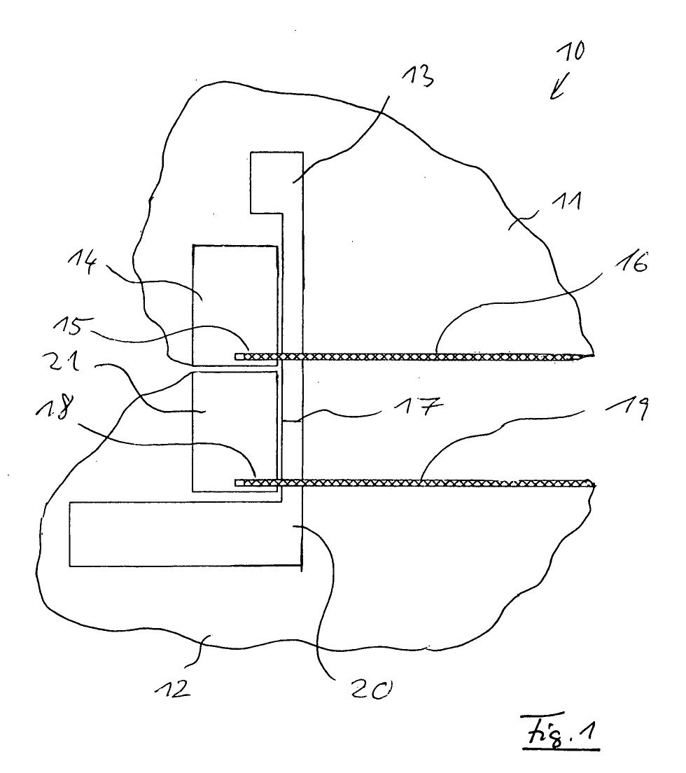

In FIGS. 1 to 4 parts of a housing of a thermoforming or vacuum moulding machine 10 are illustrated in various stages of production as details and in rough schematic form. An upper housing portion 11 and a lower housing portion 12 of the vacuum moulding machine 10 are illustrated as details in the region of a side edge of the central machining portion of the vacuum moulding machine 10. The upper housing portion 11 includes a schematically indicated clamping frame 13 and a likewise schematically indicated upper pin chain bar 14, which engages for conveyance on a lateral edge 15 of an upper portion 16 of a length of material in a way not illustrated. In the closed position of the housing the clamping frame 13 impacts on the edge 15 of the portion of the length of material and presses it, so as to seal, onto an airtight twin-sheet frame 17 arranged underneath it. The twin-sheet frame 17 in turn impacts on its underside, so as to seal, on an edge 18 of a lower portion 19 of the length of material and presses it, so as to seal, onto a schematically indicated window plate 20, which is part of the lower housing portion 12. The lower housing portion 12 furthermore includes a lower pin chain bar 21 as conveying device for the lower portion 19 of the length of material.

The portions of the length of material consist of a thermal plastics material and are held in the position according to FIG. 1, the so-called heating position of the closed chamber system formed by the upper housing portion 11 and the lower housing portion 12, as sealed laterally and are carried during heating, in a way not illustrated, by slight excess pressure.

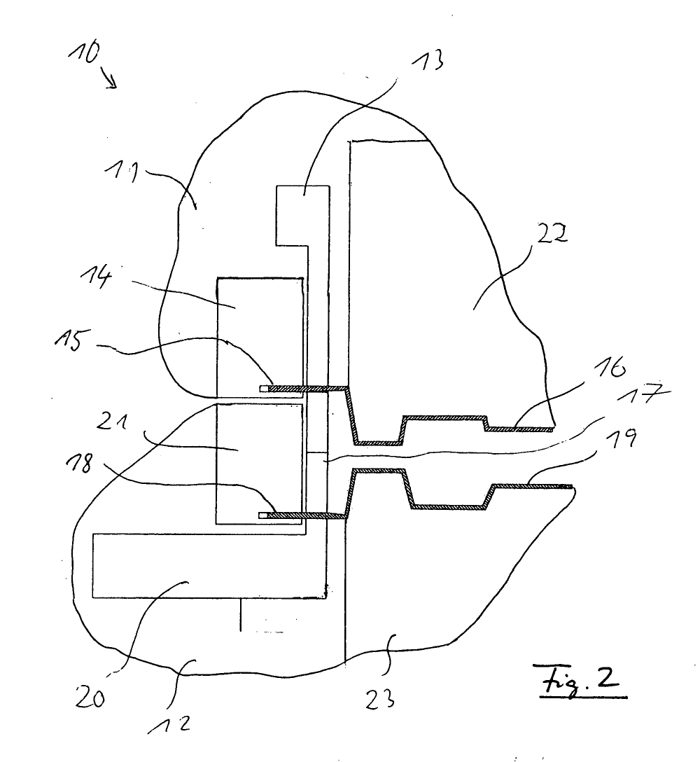

FIG. 2 shows a schematic partial illustration similar to FIG. 1, wherein, however, the upper portion 16 of the length of material has now already been deformed on a die 22 and the lower portion 19 of the length of material has been deformed on a die 23 by vacuum deformation. The deformed portions 16 and 19 of the length of material are still separate and not bonded. Die 22 is part of the upper housing portion 11, whereas die 23 is part of the lower housing portion 12. The dies 22 and 23 have been omitted in FIG. 1 for the sake of simplicity.

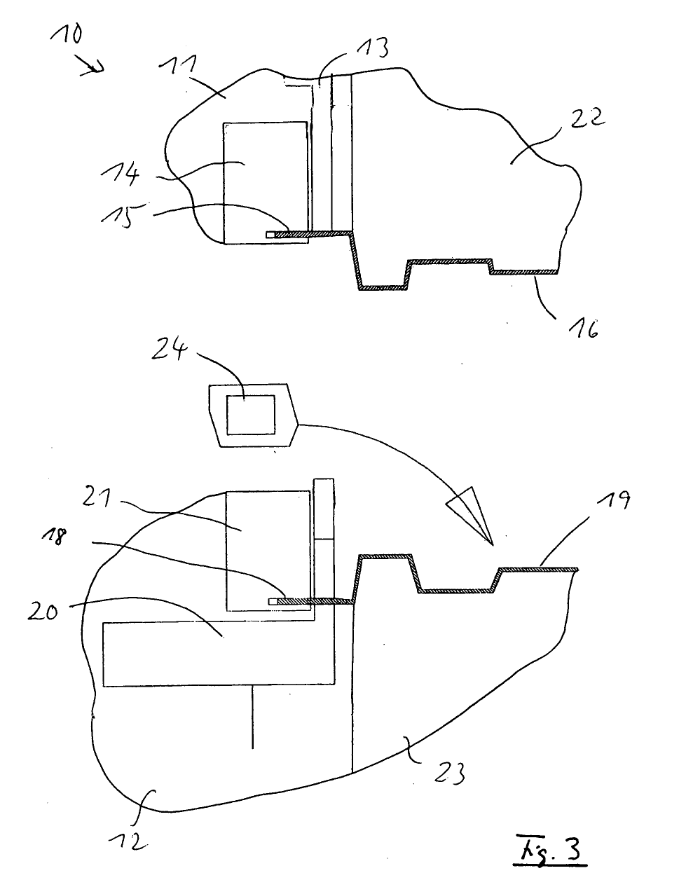

From the position shown in FIG. 3 lifting of the upper housing portion 11 thus takes place, as illustrated in FIG. 3, a lifting device, not illustrated, being provided, which is integrated, actuated electrically or by pressure means, into a sequential control for the vacuum moulding machine.

In the position illustrated in FIG. 3 the two housing portions 11 and 12 are distanced from one another to such an extent that a component 24 can be placed on the deformed lower portion 19 of the length of material. The lower deformed length of material 19 and the upper deformed length of material 16 remain clamped on the die under vacuum.

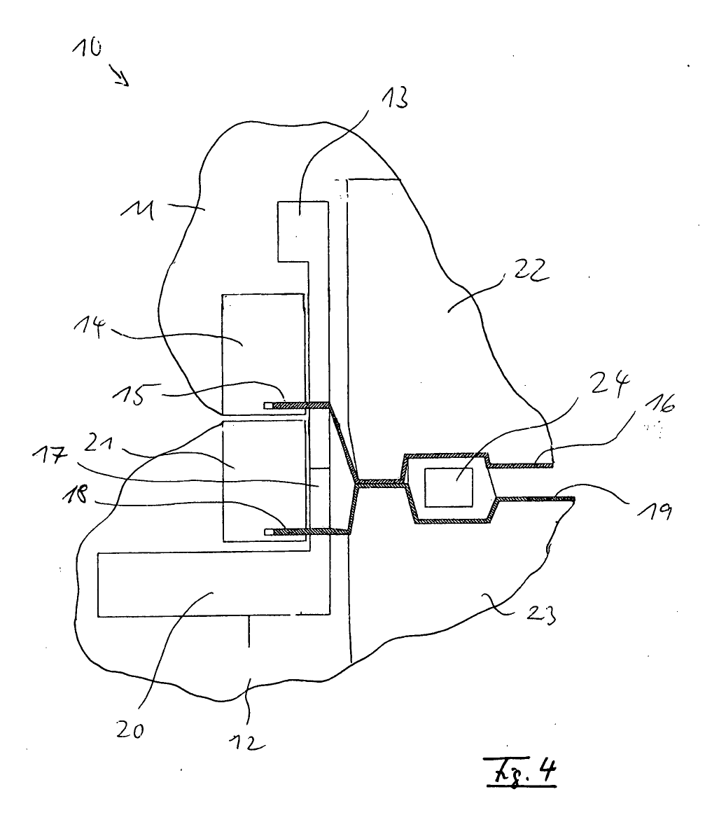

FIG. 4 shows the closed state after component 24 has been inserted and the upper deformed portion 16 of the length of material has been bonded to the lower deformed portion 19 of the length of material, with the inclusion of the inserted component 24.

Although modifications and changes may be suggested by those skilled in the art, it is the intention of the inventor to embody within the patent warranted hereon all changes and modifications as reasonably and properly come within the scope of his contribution to the art.

1. A method for producing a double-walled plastics material moulded part from portions of lengths of plastics material including at least one inserted component utilizing a closable housing of a thermoforming or vacuum moulding machine, comprising the steps of:
(a) while said housing is open, inserting an upper and a lower portion of a length of material into said housing between an upper and a lower housing portion of said housing by means of upper and lower conveying devices; said upper and lower portions of said length of material being held apart via a twin-sheet frame;
(b) to seal the arrangement of said portions of said length of material and said twin-sheet frame and at the same time to hold said portions of said length of material with a slight excess pressure during heating prior to producing deformed upper and lower portions of said length of material from said upper and lower portions of said length of material, said upper portion of said length of material is pressed onto said twin-sheet frame in a region above said twin-sheet frame by a movable clamping frame and simultaneously said lower portion of said length of material is pressed against said lower housing portion to create a closed chamber;
(c) producing said deformed upper and lower portions of said length of material by moulding said portions of said length of material by upper and lower dies spaced apart without bonding contact;
(d) moving said clamping frame, said upper die, said upper conveying device, and said deformed upper portion of said length of material with said upper housing portion from said lower housing portion at a distance for inserting said at least one component, said deformed portions of said length of material, each being held under vacuum in its relevant of said housing portions;
(e) placing said at least one component on said deformed lower portion of said length of material; and
(f) moving back said clamping frame, said upper die, said upper conveying device, and said deformed upper portion of said length of material to said lower housing portion to close and bond said moulded part to the at least one inserted component.

2. The method of claim 1, comprising moving together said clamping frame, said upper die, said upper conveying device, and said deformed upper portion of said length of material onto said deformed upper portion of said length of material while maintaining a vacuum on said upper side.

3. The method of claim 1, comprising moving said clamping frame, said upper die, said upper conveying device, and said deformed upper portion of said length of material by means of a lifting device.

4. The method of claim 1, wherein in step (f) said deformed upper portion of said length of material is pressed onto said twin-sheet frame, which presses said deformed lower portion of said length of material onto a window plate of said lower housing portion.

5. The method of claim 4, comprising pressing said lower portion of said length of material against a window plate.

6. The method of claim 6, wherein said window plate is adjustable.

7. The method of claim 1, comprising conveying said portions of said length of material by means of pin chain bars.

8. A device for producing a double-walled plastics material moulded part from portions of lengths of plastics material including at least one inserted component utilizing a closable housing of a thermoforming or vacuum moulding machine; said housing comprising:
a lower housing portion, and
an upper housing portions; wherein
between said lower and upper housing portions an upper and a lower portion of a length of material are movable by means of upper and lower conveying devices when said housing is not closed;
when said housing is closed, an airtight twin-sheet frame is arranged between said portions of said length of material, wherein said upper portion of said length of material is pressed onto said twin-sheet frame by means of a clamping frame, said twin-sheet frame is pressed onto said lower portion of said length of material, and said lower portion of said length of material is pressed onto a window plate of said lower housing portion for the purpose of sealing; and
said upper housing portion can be moved away from said lower housing portion, after individual portions of said length of material have been moulded and before said moulded part has been closed and bonded, at a distance which is sufficient for inserting said at least one component.

9. The device of claim 8, wherein said upper housing portion is movable away from said lower housing portion together with said upper moulded portion of said length of material, an upper die, said clamping frame, and said upper conveying device for said upper portion of said length of material.

10. The device of claim 8, wherein a lifting device is provided for moving said upper housing portion away from said lower housing portion.

11. The device of claim 8, comprising, during moving apart of said housing portions, clamping said moulded upper and lower portions of said length of material on said upper die under vacuum.

12. The device of claim 8, wherein for heating said portions of said length of material they are held in said housing by slight excess pressure.

13. The device of claim 8, wherein pin chain bars are provided as said conveying devices.
